(19) United States
(12) Patent Application Publication
(10) Pub. No.: US 2009/0178339 A1
(43) Pub. Date: Jul. 16, 2009

(54) Unique compression swivel

(76) Inventors: Paul T. Kicher, Willoughby Hills, OH (US); Thomas P. Kicher, Willoughby Hills, OH (US)

Correspondence Address: MCDONALD HOPKINS LLC, 600 Superior Avenue, East, Suite 2100, CLEVELAND, OH, 44114-2653, US

(21) Appl. No.: 12/283,200

(22) Filed: Sep. 10, 2008

Related U.S. Application Data
(60) Provisional application No. 60/993,129, filed on Sep. 10, 2007.

(51) Int. Cl. E05D 15/38

(52) U.S. Cl. 49/199

(57) ABSTRACT

The present invention provides an apparatus for operating a garage door. An embodiment of an operating mechanism for a door includes a shaft, a drum, an energy storing member, and a swivel body. The shaft is coupled to the door such that the shaft rotates in a first direction as the door is opened and rotates in a second direction as the door is closed. The coupling of the shaft to the door is typically accomplished by a cable. The drum is coupled to the shaft and the energy storing member is coupled to the drum by another cable. The energy storing member is arranged such that the energy storing member stores energy as the door is closed and releases stored energy as the door is opened to assist in the raising and lowering of the door.

### CROSS-REFERENCE TO RELATED APPLICATIONS

This application claims benefit from U.S. Provisional Patent Application No. 60/993,129, entitled “Unique Compression Swivel,” filed on Sep. 10, 2007, which is hereby incorporated in its entirety by reference.

### FIELD OF THE INVENTION

The present invention relates generally to the mechanical connection of a gas spring piston rod, and more particularly to a unique compression swivel connection for the gas spring for a garage door lift system.

### BACKGROUND OF THE INVENTION

The invention described herein may be used with the subject matter disclosed in U.S. Pat. No. 6,983,785, issued on Jan. 10, 2006, and titled DOOR OPERATING MECHANISM AND METHOD OF USING THE SAME, and the subject matter disclosed in U.S. Patent Publication No. 2007/0137801, published on Jun. 21, 2007, and titled GARAGE DOOR OPERATING APPARATUS AND METHODS, which are both hereby expressly incorporated by reference herein in their entirety.

Gas springs are used in many different applications to store energy related to motion in a specified direction for later release in the opposite direction. Gas springs have long been used to provide substantial energy storage and release to assist in the opening or closing of hoods and backdoors of cars and SUVs. By using such gas springs, the often heavy weight of these hoods or doors can be used to store significant amounts of energy in the gas springs that will later be used to assist in opening these heavy objects.

A Gas spring structure generally includes a pressure tube, piston rod, oil seal, and oil. Depending on the weight of the object to be supported, nitrogen gas with appropriate pressure may be used to produce the intended force. Generally, the piston rod is held within the pressure tube so that the any movement by the piston rod against the internal pressure of the pressure tube will result in an opposite spring force being exerted against the piston rod. Because the gas spring is a closed system, as the rod is pushed into its body, the internal gas is compressed due to the volumetric change so as to increase pressure, thereby exerting an opposite force on the piston rod.

When mounting a gas spring to an object, it is important to mount the rod of the gas spring securely to its base. Many types of mounting arrangements utilize a threaded section along the end of the of the piston rod which connects to a threaded aperture in a base. However, in such an arrangement it is always necessary to grab or clamp the piston rod in order to threadedly engage the piston rod end. Such contact can often scar the piston rod surface which can disturb the consistent operation of the gas spring. Such scarring leads to the gas leakage around the seal and scar so at to reduce pressure and performance.

Further, because of the construction of gas springs identified above, it is often difficult to make the piston rod connection with sufficient torque to overcome the possible release of the connection due to constant cycling. Further, due to possible rotation of the base about the piston rod or the piston rod within the base, loosening or overtightening of the connection is possible. As indicated above, loosening can lead to release of the connection and overtightening can lead to binding and undesirable friction. Therefore, there is a need in the art to provide an improved structure for connecting gas spring piston rods to their base so that the operation and duration of use of the gas spring is not compromised.

While gas springs having an improved connection structure can be used in numerous applications, this disclosure will focus on their use with a garage door operating mechanism for the purpose of simplicity. However, it should be clear to those skilled in the art that this improved connection structure could be used on any number of other applications which require a gas spring connection.

Most systems for operating garage doors utilize torsion springs to assist in lifting the garage door. Such torsion-spring-based systems function as follows: A shaft is normally located above the door opening and a pair of door drums are mounted to the shaft. Cables connect the door drums to the bottom of the garage door so that as the garage door is raised, the shaft and door drums rotate so that the cables are wound around the drums. Therefore, as the garage door is lowered, those shaft and door drums rotate in the opposite direction so that the cables are unwound from the door drums and the garage door is lowered.

Generally, a torsion spring is positioned along the shaft adjacent each door drum so as to store torsional energy during the garage door lowering operation. Therefore, one end of the torsion spring is connected to the shaft and the opposite end of the torsion spring is anchored to the door opening. The torsion spring is preloaded during the installation process while the garage door is in the down position so as to provide the necessary torque to counterbalance or offset the torque that the garage door imposes on the shaft by its connection to the door drums. Thus, when the garage door is raised, the shaft rotates in a first direction, and the torsion spring releases its stored energy, thus assisting in lifting the garage door. When the garage door is lowered, the shaft rotates in the opposite direction, and the torsion spring is reloaded with energy, thereby, assisting in offsetting the weight of the door and slowing its decent while simultaneously storing energy to assist in opening the often heavy door.

However, the use of torsion springs to assist in the lifting and lowering of garage doors offers numerous disadvantages. For example, since torsion springs must be preloaded at installation, a technician performing that installation is exposed to numerous risks of injury. The technician if often on a ladder applying significant amounts of torque to preload the torsion spring. Any accident or failure can result in the instantaneous release of this torque which can cause bodily injury to the technician. Further, if the technician overloads the torsion spring or the torsion spring includes a material defect, the spring may fail suddenly with similar injury results. Due to the preload, such a failure of a spring is unpredictable and may cause the spring to strike the technician or a garage surface with great force, causing significant bodily injury or property damage. In addition, the very process of preloading a torsion spring is difficult and laborious, and many individuals are physically incapable of completing such a task. Therefore, there is a need to replace torsion springs commonly used for garage door mechanisms with safer and easier apparatuses and methods.

U.S. Pat. No. 6,983,785 discloses the use of gas springs as an alternative to torsion springs in garage door operating mechanisms. A gas spring is fixed at one end and slideably mounted along a track on the opposite end. Generally, a cable connects the gas spring to a side drum, which is attached to the shaft above the garage door. As the door is lowered, the cable winds around the side drum, causing the gas spring to compress and store energy. This compression serves to counterbalance the weight of the door and slow the decent of the door. As the door is raised, the compressed gas spring extends and releases energy, pulling the cable attached to the side drum and assisting in lifting the door.

Accordingly, the present system replaces the torsion spring with a gas spring and cable drum system. All other door components, shaft, door drums located on the shaft, and cables connecting the lower corners of the door to the drums are still used. The gas spring, like the torsion spring, is fixed at one end. However, the opposite end is slideable along a track, rather than being rotatable around the shaft. The slideable end has a pulley to allow a cable to pass around. When the door is in the closed position a cable wraps fully around a drum, referred to as a drive drum, located on the same shaft to which the door is connected. The spring is fully compressed when the door is closed. It is storing the required energy to counterbalance the door.

The cable passes from the drive drum around the pulley, attached to the slideable end of the spring, and is anchored to a fixed position. This configuration is a 2 to 1 mechanical advantage. For every inch of stroke the gas spring provides, 2 inches of cable pull off the drive drum attached to the shaft above the door. Alternatively, for every pound of force the gas spring is applying to the slideable end, a half-pound of force is applied to the drive drum. It is the force in the cable applied to the drive drum that provides the countertorque to offset or balance the torque applied to the shaft by the door weight. When the door is lifted the compressed gas spring extends by moving the slideable end. As the slideable end moves, the cable pulls the drive drum applying the countertorque to the shaft. When the door is lowered to the closed position the spring is again compressed storing the required energy to offset the door weight during the closing operation while reloading the gas spring for the next cycle.

The present invention provides a unique compression swivel mechanism that is particularly advantageous for use with gas springs. Further, as described above, the unique compression swivel is particularly useful in connection with a garage door operating mechanism.

### SUMMARY OF THE INVENTION

The present disclosure describes a unique, compression swivel connection for use with gas springs. And while any number of applications could be identified, the connection is particularly useful in combination with an apparatus for operating a garage door. An embodiment of an operating mechanism for a door includes a shaft, a drum, an energy storing member, and a swivel body. The shaft is coupled to the door such that the shaft rotates in a first direction as the door is opened and rotates in a second direction as the door is closed. The coupling of the shaft to the door is typically accomplished by a cable. The drum is coupled to the shaft and the energy storing member is coupled to the drum by another cable. The energy storing member is arranged such that the energy storing member stores energy as the door is closed and releases stored energy as the door is opened to assist in the raising and lowering of the door.

The features of the compression swivel assembly include a piston rod longitudinally extending from the gas spring, where the piston rod comprises an insert portion located at a distal end of the piston rod, a groove located on the insert portion, and a compressive load surface located adjacent the insert portion and defined by an increased cross-sectional area of the piston rod. The assembly further includes a support member comprising a bore extending longitudinally within a support member and capable of receiving the insert portion of the piston rod, a locking member aperture extending transversely through the support member and offset from the centerline of the bore, and a compression surface facing longitudinally away from said support member and capable of engaging the compressive load surface of the piston rod. Finally, a lock member is capable of insertion through the lock member aperture and capable of engagement with the piston rod groove so as to provide a freely rotating connection between the support member and the piston rod. The locking member secures the connection in place but does not carry the primary structural load. Therefore the piston rod is capable of compressive and extensive movement relative to the gas spring so as to store and release energy. Additionally, any rotation on the piston rod will not affect the connection as would be the case with a threaded connection. For example, when compressive movement occurs during the lowing of the garage door, energy is stored in the gas spring. When extensive movement occurs during the raising of the garage door, energy stored in the gas spring is release and assists in opening the garage door.

### DESCRIPTION OF THE DRAWINGS

Operation of the invention may be better understood by reference to the following detailed description taken in connection with the following illustrations, wherein:

FIG. 1 illustrates a rear view of a garage door and door operating mechanism in accordance with the present invention.

FIG. 2 illustrates a side view of the door operating mechanism.

FIG. 3 illustrates a top view of the door operating mechanism.

FIG. 4 illustrates a close up side view of a portion of the door operating mechanism of FIG. 3.

FIG. 5 illustrates a perspective view of an energy storing member assembly of the door operating mechanism.

FIG. 6 illustrates a top cross-sectional view of the energy storing member assembly.

FIG. 7 illustrates a side cross-sectional view of the energy storing member assembly.

FIG. 8 illustrates an end cross-sectional view of the energy storing member assembly of FIG. 7.

### DETAILED DESCRIPTION

While the present invention is described with reference to embodiments described herein, it should be clear that the present invention should not be limited to such embodiments. Therefore, the description of the embodiments herein is only illustrative and should not limit the scope of the invention as claimed.

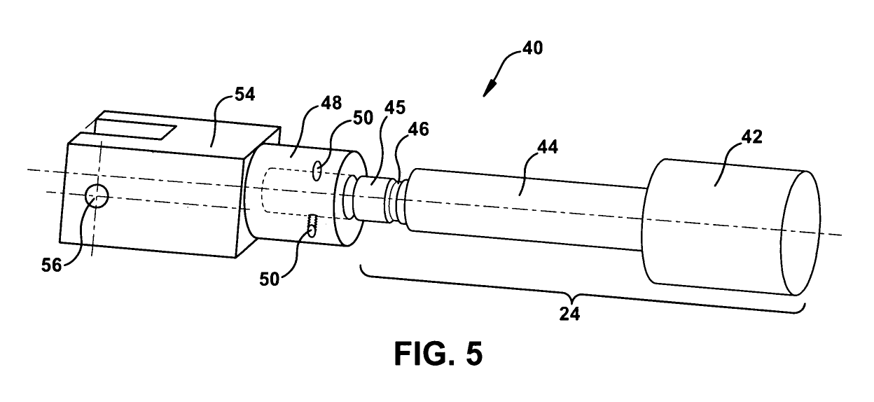

The present invention provides novel arrangements for assisting in the raising and lowering of garage doors 10. An embodiment of the present invention utilizes an energy storing device 24, such as a gas spring, coupled to a drum 28 to provide resistance force to counterbalance the weight of a door 10 as it is lowered and to provide an assisting force to counterbalance the weight of door 10 as it is raised. The energy storing device or gas spring 24 may further be connected to a structural joint assembly 40 that may support compressive loads, allow for free axial rotation and modest tensile loading. As best seen in FIG. 5, the joint 40 is shown as a connection between a clevis structure or fitting 54 and the piston rod 44 of a gas spring 24.

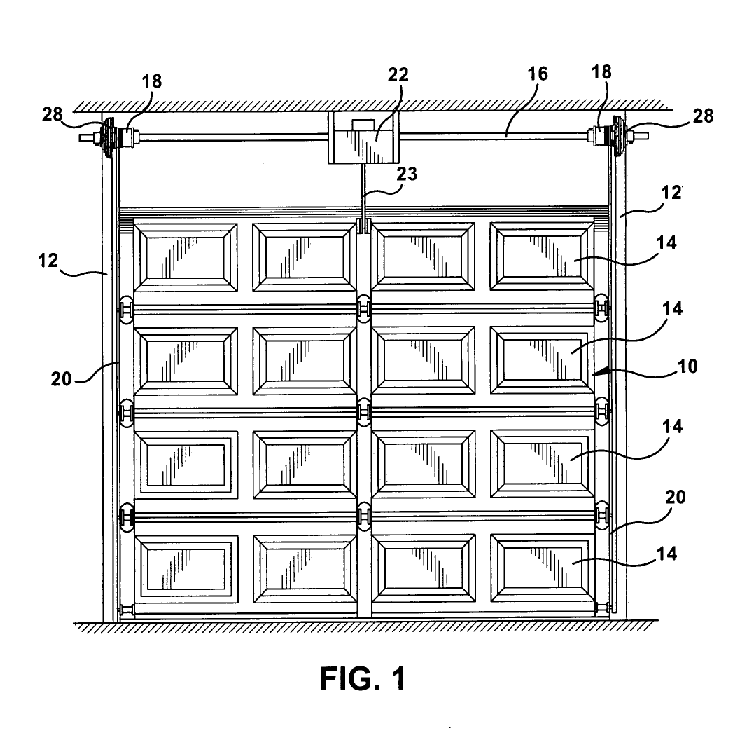

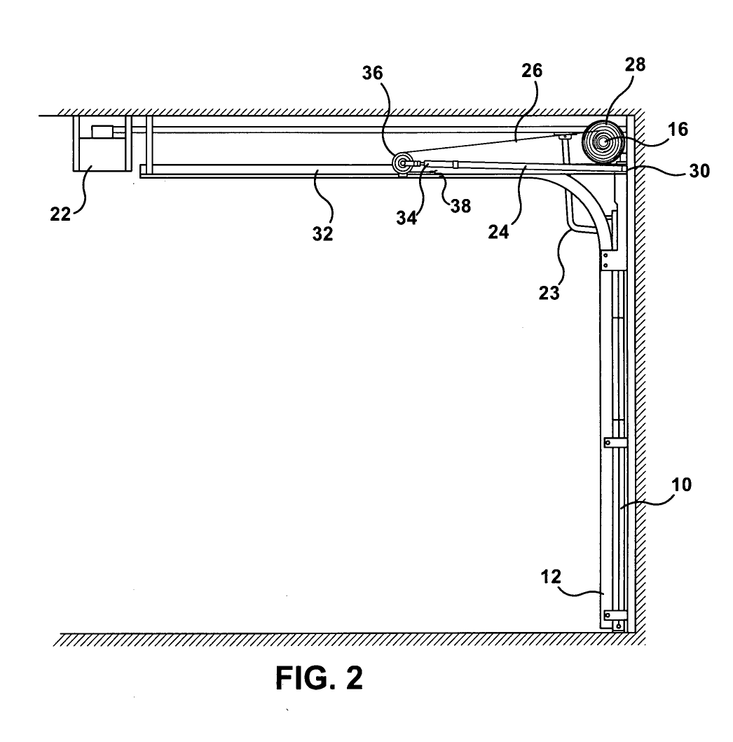

As shown in FIG. 1, a garage door 10 is arranged to be raised and lowered along a pair of tracks 12. As best seen in FIG. 2, the tracks 12 are generally L-shaped. To enable the door 10 to move along the L-shaped tracks 12, the door 10 includes a plurality of hinged panels 14. The mechanism by which the door 10 is raised and lowered includes a shaft 16, typically mounted to a garage wall above the door 10, and a pair of door drums 18 mounted on the shaft 16. As best seen in FIG. 1, a door drum 18 is mounted proximate to each end of the shaft 16, and door cables 20 connect each door drum 18 to the bottom of the door 10. As the shaft 16 rotates in a first direction, the door cables 20 wind around the door drums 18 and the door 10 rises. As the shaft 16 is rotated in the opposite direction, the door cables 20 unwind from the door drums 18 and the door 10 lowers. Optionally, a standard electric motor 22 is arranged to raise and lower the door 10. The motor 22 may be arranged to rotate the shaft 16 to raise and lower the door 10 or the motor 22 may be arranged to move a carriage coupled to the door 10 by an arm 23 (as seen in FIGS. 1 and 2) to raise and lower the door 10.

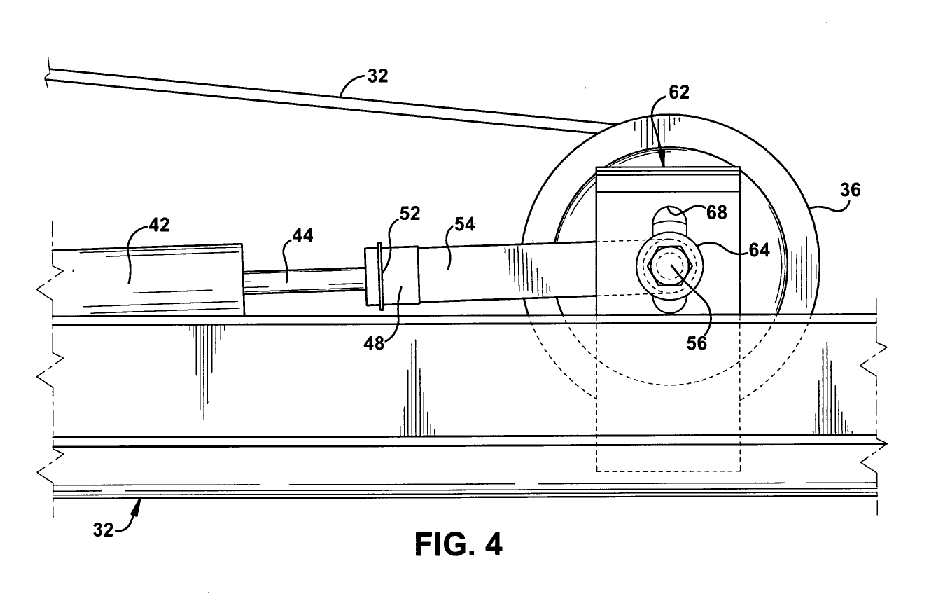

As best seen in FIG. 2, an energy storing device 24 is coupled to the shaft 16 to assist in raising and lowering the door 10. In the preferred embodiment illustrated, the energy storing device 24 is a gas spring. The gas spring 24 is coupled to the shaft 16 through a spring cable 26 and a drive drum 28. One embodiment of the drum or drive 28 is illustrated in FIG. 4. This illustration shows a nonlinear graduated drive drum 28. Although the present disclosure generally describes embodiments as including a nonlinear graduated drive drum 28, it will be readily understood by those skilled in the art that drive drums practiced with the present invention are not limited to nonlinear graduated drive drums. For example, drive drums 28 practiced with the present invention can be linear graduated drums, flat drums with constant diameters, graduated drums, where a portion of the drum is linear and a another portion is nonlinear, and the like, for example.

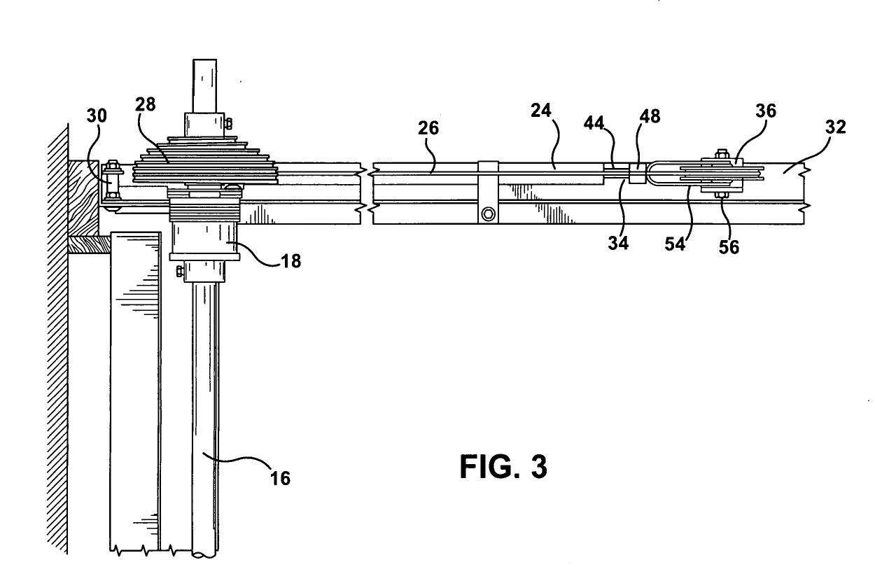

With reference to FIGS. 2 and 3, the gas spring 24 may be fixed on a first end 30 and slideably coupled to a rail 32 on a second end 34 via a joint assembly 40. A pulley wheel 36 may be attached to the slideable end 34 of the spring 24 to engage the gas spring 24 with the rail 32. The spring cable 26 may be secured to the drum 28 at one end. The spring cable 26 may extend from the drum 28, around the pulley wheel 36, and may be secured to the rail 32 by a hook 38.

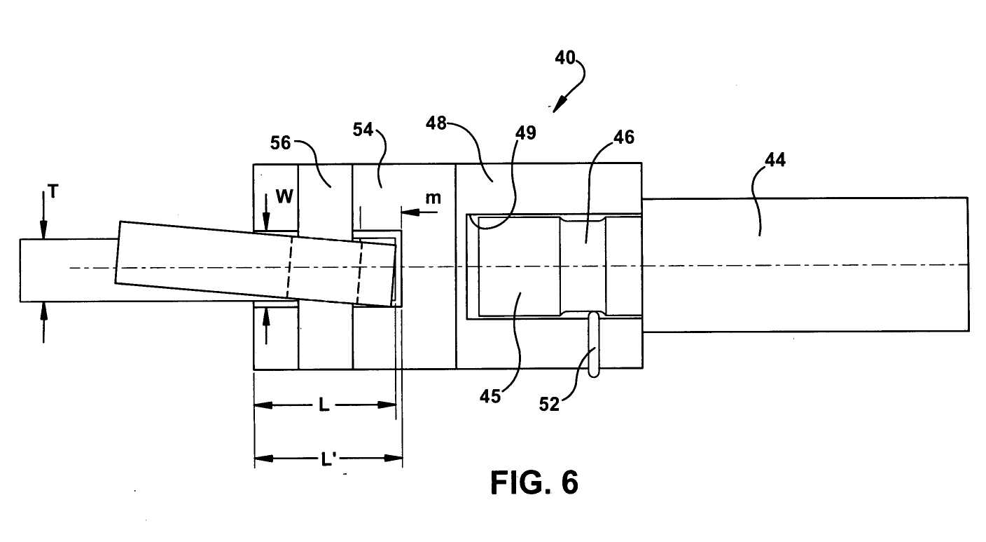

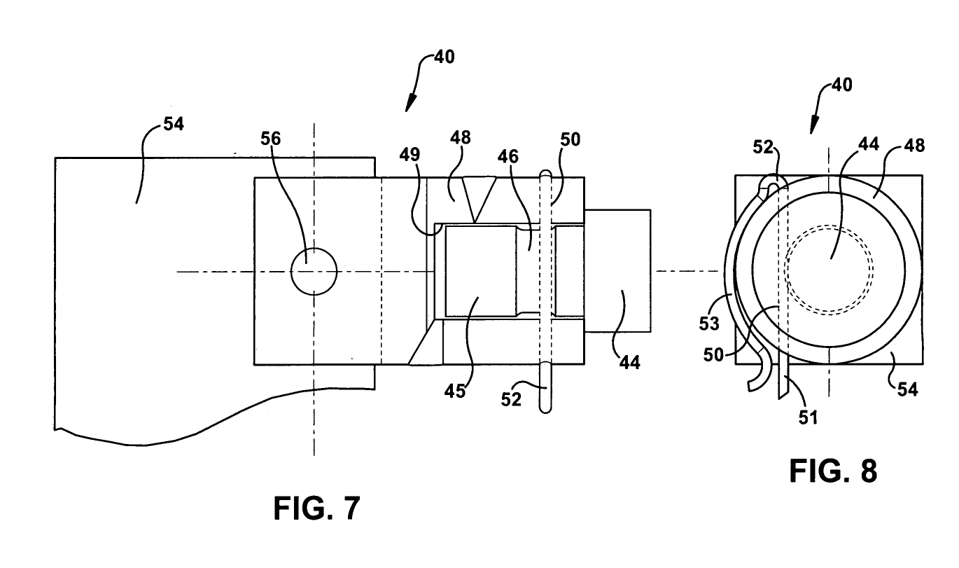

With reference to FIGS. 5-8, the joint assembly 40 may include an energy storing device 24, a swivel body 48, and a clevis structure 54. The energy storing device 24 may include a gas spring body 42 and gas spring piston rod 44. The piston rod 44 may include a recess 46 toward a piston rod end 45. The swivel body 48 may be of any appropriate shape and size, but it preferably in a cylindrical shape. The swivel body 48 may also include a bore located within its center 49 and a cavity 50. The clevis structure 54 may be of any appropriate shape or size, such as a rectangular or circular shape or the like, depending upon the situation. For example, the clevis structure 54 may be a U-shaped bracket 54. The clevis structure 54 may include a clevis pin 56 for connecting to the pulley 36.

Fully compressed gas springs 24 often exhibit a precise length dimension, since the component parts are generally manufactured with a level of precision. However, fully extended gas springs 24 often exhibit varying length dimensions, in spite of the precision of manufactured parts. The equilibrium length of the fully extended gas spring 24 can be affected by the friction of the piston seals and slight variations of length are possible. To accommodate these length variations during the assembly process, the piston rod 44 utilizes the relief or groove 50 having a width that may exceed the diameter of the retainer pin 52.

With reference to FIG. 8, the retainer pin 52 may be shaped to provide a straight tine 51 to engage the piston rod 44 and curved tine 53 to spring lock against the outside of the swivel joint. In addition, the retainer pin 52 could be designed with a feature that keeps it engaged with the swivel body 48 when the piston rod 44 is removed.

The use of simple structures and actuators often involves members whose loads are known to be compressive, such as in the case of an energy storing member or gas spring 24. The end joints 34 are required to support compressive loads of significant magnitude, but the tensile loads are modest and usually limited to the casual loading encountered during assembly and before any external loads are applied. The end joints 34 may be required to carry a modest tensile load when the gas springs 24 are at their full extension, when further motion of the mechanism would dislodge the gas spring 24 from its proper position. The fittings must maintain the assembly 40 of components in anticipation of a loading that would place the gas spring 24 in compression.

Bending loads at the joints are avoided to maintain the member forces in a purely axial alignment. Gas springs 40 must avoid bending loads at the end connections to allow for the free movement of the gas spring piston 44. Torsional loading of the joint is generally not an issue for structures and devices of this type, but might be encountered in the assembly of the joint while attempting to align the two end devises 54 with their mating parts, such as a pulley 36, for example. The free rotation of the joint is allowed since the retainer pin 52 engages the piston rod 44 via a circumferential groove 46 in the piston rod 44. This swivel configuration 48 is proposed as an alternative to a threaded connection and offers several advantages, including allowing the assembly of the clevis joint 54 before engaging the gas spring piston rod 44, for example. FIG. 5 shows the swivel body 48 attached to a clevis structure or joint 54. The swivel body 48 could be fabricated as part of or attached to joints of other configurations, such a ball joints or fixed retainers. Although the swivel body 48 is shown with the cavity 50 located towards the gas spring 24, it is possible to have multiple locations in the swivel body 48 for the retainer pin 52, so that the retainer pin 52 may be placed at any desirable and appropriate location. In addition, the gas spring piston rod 44 and gas spring body 42 may freely rotate when a swivel body 48 is used on both ends.

The joint assembly 40 of the present invention allows the compression load to be carried by the piston rod 44. As the piston rod 44 of the gas spring 24 bears on the swivel body 48 at the collar or piston rod end 45, the tensile load may be carried by the retainer pin 52. In addition, the axial alignment between the piston rod 44 and swivel body bore 49 may be maintained by the close fit or proximity between the piston rod end 45 and the swivel body bore 49.

Unlike the prior art, the present invention provides for a lower cost of manufacture, faster installation time, as well as allowing for alternative assembly sequences and procedures. In addition, since any threaded ends that may be located at the first end 30 are generally assembled prior to the clevis structure 54 being engaged, the joint assembly 40 will not disengage the opposite end 30 when attempting to align, as in the case of a threaded joint. Moreover, the swivel body 48 can be attached to various joints, e.g., clevis, ball and socket, fixed retainers, and the like, no tools are needed to assemble, reduced risk of damage to the piston rod 44 during assembly, and does not require a thread lock to secure the assembly 40.

The gas spring 24 may be arranged such that as the door 10 is lowered, the spring cable 26 winds around the drum 28, and the spring 24 compresses and pressurizes to store energy. As the door 10 is raised, the spring cable 26 may unwind from the drum 28 and the gas spring 24 may extend and release the stored energy. As the electric motor 22 is actuated to raise the door 10, the shaft 16 may begin to rotate, which may unwind the spring cable 26 from the drum 28. This movement allows the gas spring 24 to extend and release stored energy. The release of this energy assists the shaft 16 in rotating, thus assisting in lifting the door 10.

Conversely, when the door 10 is in an open or raised position, the spring cable 26 may be unwound from the drum 28 and the spring 24 may be extended. As the electric motor 22 is actuated to lower the door 10, the shaft 16 may begin to rotate in the opposite direction, which may wind the spring cable 26 on the drum 28. This movement compresses the gas spring 24, which stores energy. This storing of energy resists the rotation of the shaft 16, thereby slowing movement of the door 10 as it is lowered.

Although the present disclosure generally describes embodiments as including a gas spring that compresses to store energy and extends to release energy, it will be readily understood by those skilled in the art that energy storing devices practiced with the present invention are not limited to compression gas springs. Generally, the present application can be practices with any energy storing device that can store and subsequently release energy. For example, the present invention may be practiced with a gas spring that is arranged to extend when storing energy and contract (or compress) when releasing energy.

With further reference to FIGS. 2 and 3, a mechanical advantage of 2 to 1 is achieved. For every inch of stroke the gas spring 24 provides, two inches of spring cable 26 may be wound on or off the graduated drum 28 that is attached to the shaft 16. For every pound of force the gas spring 24 applies to the slideable end 34, a half-pound of force may be applied to the graduated drum 28.

Whether a garage door 10 is operated by an electric motor, opened and closed manually, or by some other mechanism, there are force profiles (i.e., the force required to move the door as a function of the door position) that produce preferred behavior. For example, when manually opening a door, it is preferable that the force needed to raise the door from the closed to the open position is constant for the first 90% to 95% of the travel of the door, and the final 5% to 10% of the travel of the door requires no additional force from the operator. In other words, the door pulls itself up the last 5% to 10% of the travel distance. This arrangement provides the operator with confidence that the door will not fall back down, thereby avoiding physical injury or property damage.

The height of the door will determine the displacement needed to move a door from a closed to an open position. Most commonly, garage doors are manufactured in 7 foot and 8 foot heights. In implementing a drive drum system, whether the drum is nonlinear, linear, graduated, flat or any combination thereof, maintenance of a constant number of shaft rotations in moving a door from the closed to the open position is preferred. Otherwise, a different drive drum would need to be manufactured for each door height, which may lead to the need for different lengths of gas springs. It is preferable to maintain a consistent graduated drum and gas spring. Door drums are typically 4 inches in diameter, which requires approximately 6.5 revolutions to open a 7 foot door and 7.5 revolutions to open an 8 foot door. To maintain consistent drive drums and gas springs, the 4 inch door drum is used with 7 foot doors and a 4.58 inch door drum is used with 8 foot doors. This results in the shaft rotating 6.5 times regardless of whether the height of the door is 7 or 8 feet. It will be immediately recognized that the door drum may be adjusted for doors of any size to maintain 6.5 shaft revolutions to move a door from a closed to an open position.

It is preferable to use a spring with more stroke available than needed. For example, with the graduated drum 28 illustrated in FIG. 3 and a 5:1 mechanical advantage arrangement, only 12.75 inches of stroke are needed to rotate the graduated drum 6.5 revolutions to move the door between the open and closed positions. If a spring with a stroke of 16.14 inches is used, there will be 3.39 inches remaining to allow for fine adjustments to the force. The spring could start partially compressed to 3.39 inches and still have enough stroke remaining for 6.5 revolutions.

While the invention has been described with reference to the preferred embodiment, and other alternate embodiments also have been disclosed, additional embodiments, modifications, and alternations would be obvious to one skilled in the art upon studying the disclosure and drawings. All of the additional embodiments, modifications, or alterations encompassing the spirit of the invention are claimed by the applicants to the extent that they are within scope of the claims or the equivalent thereof.

Having thus described the invention, I claim:

1. An operating mechanism for a door comprising:
a shaft coupled to said door wherein said shaft rotates in a first direction as said door is opened and rotates in a second direction as said door is closed;
a drum coupled to said shaft;
an energy storing member coupled to said drum wherein said energy storing member stores energy as said door is closed and releases stored energy as said door is opened; and
a swivel body coupled to said energy storing member at a first end and coupled to a clevis at a second end.

2. The door operating mechanism of claim 1 wherein said energy storing member includes a fixed first end and a second end moveable with respect to said first end.

3. The door operating mechanism of claim 1 wherein said energy storing member further includes a recess located towards said second end.

4. The door operating mechanism of claim 1 wherein said swivel body includes a retainer pin cavity.

5. The door operating mechanism of claim 1 wherein said swivel body is coupled to said energy storing member by a retainer pin through said retainer pin cavity.

6. The door operating mechanism of claim 1 wherein as said energy storing member releases energy, said energy storing member encourages the rotation of said shaft in said first direction.

7. The door operating mechanism of claim 1 wherein as said energy storing member stores energy, said energy storing member resists the rotation of said shaft in said second direction.

8. The door operating mechanism of claim 1, wherein said drum is an at least partially graduated drum.

9. The door operating mechanism of claim 8 wherein graduation of said at least partially graduated drum is nonlinear.

10. The door operating mechanism of claim 1 wherein said energy storing member is coupled to said drum by a cable.

11. The door operating mechanism of claim 1 wherein said energy storing member is a gas spring.

12. The door operating mechanism of claim 11, wherein said gas spring includes a piston rod and a spring body.

13. The door operating mechanism of claim 12 wherein said piston rod includes a circumferential groove.

14. The door operating mechanism of claim 13 wherein said swivel body allows for free axial rotation of said energy storing member via said circumferential groove.

15. The door operating mechanism of claim 12 wherein axial alignment between said swivel body and said piston rod is maintained by a close fit between said piston rod and said swivel body.

16. The door operating mechanism of claim 12 wherein a compression load is carried by said piston rod bearing on said swivel body.

17. The door operating mechanism of claim 15, wherein a tensile load is carried by said retainer pin.

18. The door operating mechanism of claim 2 wherein as said door is closed, said second end moves towards said first end and as said door is opened, said second end moves away from said first end.

19. A compression swivel assembly for use with a garage door operating mechanism, said assembly comprising:
a gas spring capable of storing energy generated while lowering a garage door;
a piston rod longitudinally extending from said gas spring, said piston rod comprising:
an insert portion located at a distal end of said piston rod;
a groove located on said insert portion;
a compressive load surface located adjacent said insert portion and defined by an increased cross-sectional area of said piston rod;
a support member comprising:
a bore extending longitudinally within said support member and capable of receiving said insert portion of said piston rod;
a lock member aperture extending radially through said support member and through said bore; and
a compression surface facing longitudinally away from said support member and capable of engaging said compressive load surface of said piston rod;
a lock member capable of insertion through said lock member aperture and capable of
engagement with said piston rod groove so as to provide a swivel connection between said support member and said piston rod; and
wherein said piston rod is capable of compressive and extensive movement relative to said gas spring so that when said compressive movement occurs during the lowing of said garage door, energy is stored in said gas spring and when said extensive movement occurs during the raising of said garage door, energy stored in said gas spring is release and assists in opening the garage door.
